(19) United States
(12) Patent Application Publication
(10) Pub. No.: US 2025/0124583 A1
(43) Pub. Date: Apr. 17, 2025

(54) IMAGE PROCESSING DEVICE AND METHOD HAVING MOTION DETECTION MECHANISM

(71) Applicant: SigmaStar Technology Ltd., Xiamen (CN)

(72) Inventor: Fu-Cheng CHEN, Zhubei City (TW)

(21) Appl. No.: 18/901,373

(22) Filed: Sep. 30, 2024

(30) Foreign Application Priority Data
Oct. 11, 2023 (CN) 202311315030.7

(51) Int. Cl. G06T 7/20

(52) U.S. Cl. CPC G06T 7/20

(57) ABSTRACT

An image processing device includes a memory, an image generator and a motion detection circuit. The image generator generates first data based on input image data and stores the first data to the memory. The motion detection circuit detects whether there is a presence of a motion detection event in the input image data. Before the motion detection circuit detects the presence of the motion detection event, the image generator stores the first data in a first period, and after the motion detection circuit detects the presence of the motion detection event, the image generator stores the first data in a second period, wherein the first period is longer than the second period

This application claims the benefit of China application Serial No. CN202311315030.7, filed on Oct. 11, 2023, the subject matter of which is incorporated herein by reference.

### BACKGROUND OF THE INVENTION

### Field of the Invention

The present application relates to an image processing device, and more particularly to an image processing device and method having a motion detection mechanism.

### Description of the Related Art

In general, a driving recorder uses a high-performance video capturing chip (operated by a host device) to capture videos. When a vehicle is parked, the driving recorder enters a parking mode for monitoring. However, in the prior art, the driving recorder operating in a parking mode still uses the video capturing chip for capturing, resulting in high power consumption and may fail to meet image capturing requirements over an extended period of time of parking.

### SUMMARY OF THE INVENTION

In some embodiments, it is an object of the present application to provide an image processing device and method, which has a motion detection mechanism and generates image data in different periods to reduce power consumption, so as to improve the issues of the prior art.

In some embodiments, an image processing device includes a memory, an image generator and a motion detection circuit. The image generator generates first data based on input image data and stores the first data to the memory. The motion detection circuit detects whether there is a presence of a motion detection event in the input image data. Before the motion detection circuit detects the presence of the motion detection event, the image generator stores the first data in a first period, and after the motion detection circuit detects the presence of the motion detection event, the image generator stores the first data in a second period, wherein the first period is longer than the second period.

In some embodiments, an image processing method includes operations of: generating first data based on input image data; detecting whether there is a presence of a motion detection event in the input image data; before the presence of the motion detection event is detected, storing the first data to a memory in a first period, and after the presence of the motion detection event is detected, storing the first data to the memory in a second period, wherein the first period is longer than the second period.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an image processing device according to some embodiments of the present application;

FIG. 2 is a flowchart of operations of the image processing device in FIG. 1 according to some embodiments of the present application;

FIG. 3 is a schematic diagram of data in FIG. 1, data processed by a motion detection circuit and input image data according to some embodiments of the present application;

FIG. 4 is a schematic diagram of an application example of the image processing device in FIG. 1 according to some embodiments of the present application; and

FIG. 5 is a flowchart of an image processing method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

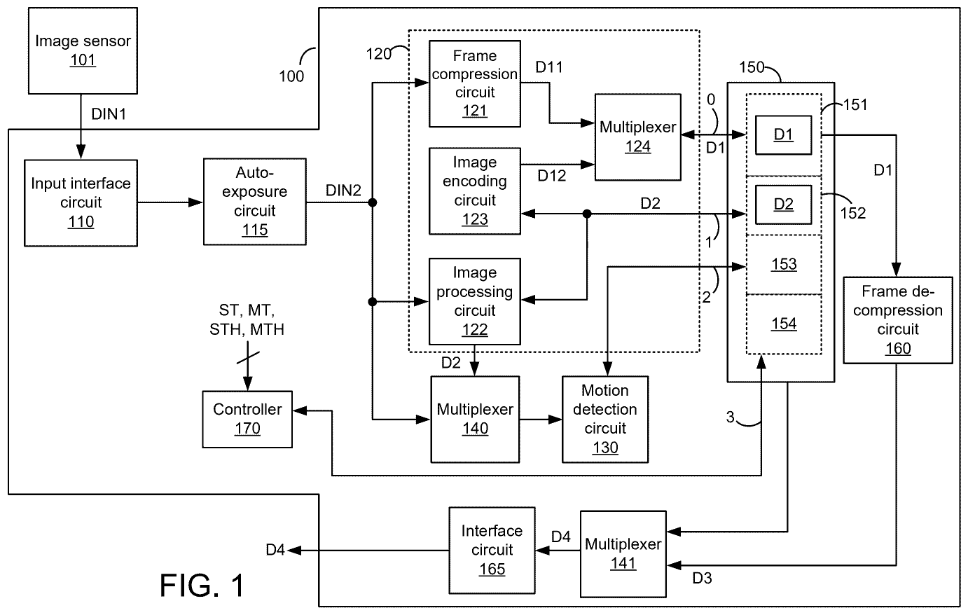

FIG. 1 shows a schematic diagram of an image processing device 100 according to some embodiments of the present application. The image processing device 100 may receive input image data DIN1 from an image sensor 101, and generate multiple sets of image data in different formats based on the input image data DIN1.

The image processing device 100 includes an input interface circuit 110, an auto-exposure circuit 115, an image generator 120, a motion detection circuit 130, a multiplexer 140, a multiplexer 141, a memory 150, a frame decompression circuit 160, an interface circuit 165 and a controller 170. The input interface circuit 110 may receive the input image data DIN1 from the image sensor 101, and transmit the input image data DIN1 to the auto-exposure circuit 115. In some embodiments, the input interface circuit 110 may be, for example but not limited to, a digital video port circuit. The auto-exposure circuit 115 may generate an exposure parameter for controlling the image sensor 101 according to the input image data DIN1, and generate input image data DIN2. In some embodiments, the input image data DIN2 is equivalent to raw image data.

The image generator 120 may generate data D1 based on the input image data DIN2, and store the data D1 to a storage space 151 of the memory 150 through a connection port 0. In some embodiments, the image generator 120 may include a frame compression circuit 121, an image processing circuit 122, an image encoding circuit 123 and a multiplexer 124. The frame compression circuit 121 may generate data D11 based on the input image data DIN2. For example, each pixel data in the input image data DIN2 is 8-bit data. The frame compression circuit 121 may compress the input image data DIN2, such that each pixel data is reduced to 6-bit data to thereby generate the data D11. In some embodiments, the data D11 may be compressed raw image data.

The image processing circuit 122 may generate the data D2 based on the input image data DIN2, and store the data D2 to a storage space 152 of the memory 150 through a port 1. In some embodiments, the image processing circuit 122 may perform image processing on the input image data DIN2, for example but not limited to, auto white balance and image format conversion (for example, conversion into the YUV format), so as to generate the data D2. The image encoding circuit 123 may read the data D2 from the storage space 152 to thereby generate D12 based on the data D2. For example, the image encoding circuit 12 may encode the data D2 by an image encoding technique to generate the data D12. In some embodiments, the data D12 may be a Joint Photographic Experts Group (JPEG) image file. In some embodiments, a data amount (or a data size) of the data D11 is greater than a data amount (or a data size) of the data D12. For example, the data D11 may be raw image data, the data D12 may be a JPEG file, and both of the above may correspond to complete contents of a same frame.

The multiplexer 124 may receive the data D11 and/or the data D12, and output one of the data D11 and the data D12 according to a configuration of the controller 170 as the data D1, thereby storing the data D1 to the storage space 151 through the port 0. In some embodiments, the controller 170 may selectively enable one of the frame compression circuit 121 and the image processing circuit 122, so as to selectively generate the data D11 or the data D12. Thus, the circuit that is not enabled does not perform any related operations, hence better reducing power consumption.

The multiplexer 140 may transmit the data D2 or the input image data DIN2 to the motion detection circuit 130 according to a configuration of the controller 170, such that the motion detection circuit 130 may detect whether there is a presence of a motion detection event in the input image data DIN2 according to the received data. For example, the motion detection circuit 130 may analyze whether there is an obvious pixel difference or object profile in two consecutive frames in the received data to determine whether there is a presence of a motion detection event in the input image data DIN2. If the presence of a motion detection event is detected, the motion detection circuit 130 may issue an interrupt signal (not shown) to the controller 170, so as to notify the controller 170 of the presence of a motion detection event. The motion detection circuit 130 may store analyzed data and/or related temporary data to a storage space 153 of the memory 150 through a port 2. It should be noted that the operation details of the motion detection event are examples, and are not to be construed as limitation to the present application.

The controller 170 may control the memory 150 to output the data D1 from the storage space 151. More specifically, the controller 170 may be configured to control and/or configure operations of multiple circuits in the image processing device 100. In some embodiments, the controller 170 may include multiple registers (not shown) for configuring the multiple circuits above. For example, the controller 170 may set a parameter of a first register of these registers, so that the image generator 120 selectively enables the frame compression circuit 121 or the image processing circuit 122 according to the parameter in the first register, and controls the multiplexer 124 to output the data D11 or the data D12 as the data D1. Similarly, the controller 170 may set a parameter of a second register of these registers, so that the multiplexer 140 may transmit one of the data D2 and the input image data DIN2 to the motion detection circuit 130 according to the parameter in the second register. In some embodiments, the controller 170 may temporarily store parameters related for configuring operations of other circuits to a storage space 154 of the memory 150 through a port 3. With the configuration above, the multiple circuits above may operate collaboratively according to the configuration of the controller 170, and share the same memory 150. In some embodiments, the multiple ports 0 to 3 may be, for example but not limited to, internal memory interface ports. In some embodiments, the memory 150 may be, for example but not limited to, a static random access memory (SRAM). In some embodiments, the controller 170 may be a microprocessor and/or microcontroller executing a predetermined process or software, and is, for example but not limited to, a 8051 single-chip microcontroller.

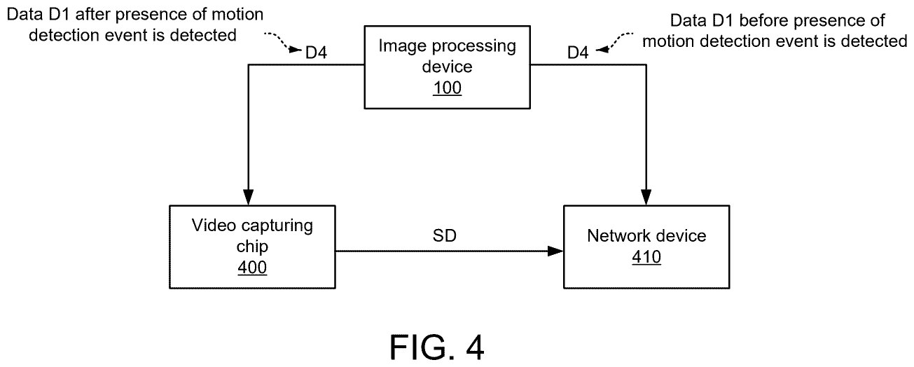

The frame decompression circuit 160 may read the data D1 from the storage space 151 and generate data D3 based on the data D1. In the foregoing example, each pixel data in the input image data D1 is 6-bit data. The frame decompression circuit 160 may recover each of these pixel data into 8-bit data so as to generate the data D3. According to the control of the controller 170, the multiplexer 170 may read other data from the memory 150, or output the data or the data D3 as data D4. The interface circuit 165 may receive the data D4 from the multiplexer 141, and transmit the data D4 to at least one host device (for example but not limited to, a video capturing chip 400 and/or a network device 410 in FIG. 4), so as to perform subsequent image applications. In some embodiments, the interface circuit 165 may be, for example but not limited to, a Serial Peripheral Interface (SPI) slave controller.

It should be noted that the above configuration details of the image processing device 100 in FIG. 1 are merely examples, and the present application is not limited to these examples. In an actual application, the image processing device 100 may further include an Inter-Integrated Circuit (12) bus, a master/slave controller, an infrared controller, a timer or a clock generator. In some embodiments, the multiple circuits described with reference to FIG. 1 may be implemented by at least one digital circuit having an image processing or data conversion ability.

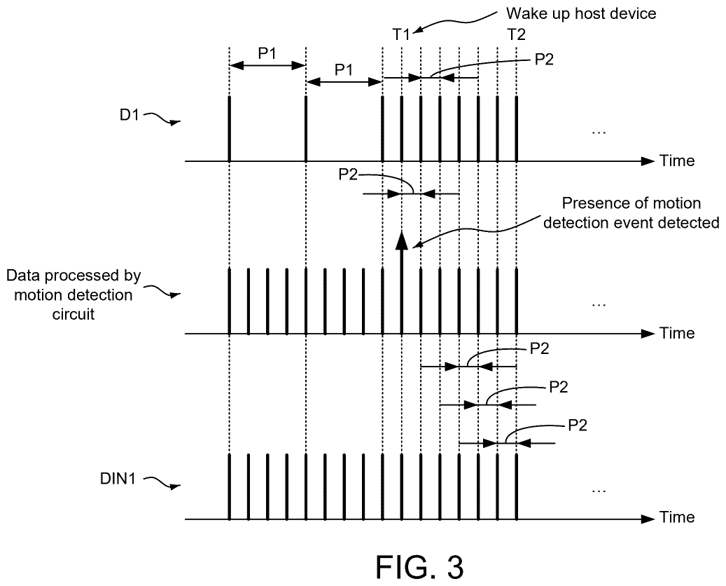

In some embodiments, the multiple registers above may further store a parameter ST, a parameter STH, a parameter MT and a parameter MTH. The controller 170 may set the multiple parameters above according to requirements of the at least one host device described above. In some embodiments, the controller 170 may control, according to the parameter ST and the parameter STH, the image generator 120 to store the data D1 in a first period before the motion detection circuit 130 detects the presence of the motion detection event, and control, according to the parameter MT and the parameter MTH, the image generator 120 to store the data D1 after the motion detection circuit 130 detects the presence of the motion detection event, wherein the first period is longer than the second period. In other words, before the motion detection circuit 130 detects the presence of the motion detection event, the image generator 120 captures contents of the input image data DIN2 at a longer time interval (for example, a period P1 in FIG. 3), and stores the captured data as the data D1. In contrast, after the motion detection circuit 130 detects the presence of the motion detection event, the image generator 120 captures contents of the input image data DIN2 at a shorter time interval (for example, a period P2 in FIG. 3), and stores the captured data as the data D1. Related operation details of the above are to be described with reference to FIG. 3 below. In some embodiments, the parameter ST may set the first period, and the parameter MT may set the second period. For example, the first period and the second period may be defined by the number of frames. If the parameter ST is set to 5, it means that before the motion detection circuit 130 detects the presence of the motion detection event, the image generator 120 captures one out of every five frames to generate the data D1. Similarly, if the parameter MT is set to 1, it means that after the motion detection circuit 130 detects the presence of the motion detection event, the image generator 120 captures every frame to generate the data D1. It should be noted that the above numerical values of the parameter ST and the parameter MT are merely examples, and the present application is not limited to these examples. In some embodiments, the numerical value of each the parameter ST and the parameter MT may be, for example but not limited to, an integer greater than or equal to 0.

In some embodiments, if the first period defined by the parameter ST is greater than or equal to a predetermined value, the controller 170 may operate in a power-saving mode before the motion detection circuit 130 detects the presence of the motion detection event. In other words, if the first period is long enough, the controller 170 may operate in a power-saving mode during a period before the presence of the motion detection event is detected, and be woken up according to the number of frames defined according to the parameter ST, thereby performing a corresponding operation. Thus, the overall power consumption can be further reduced.

In some embodiments, the parameter STH may set a maximum number of frames of the data D1 before the motion detection circuit 130 detects the presence of the motion detection event, and the parameter MTH may set a maximum number of frames of the data D1 after the motion detection circuit 130 detects the presence of the motion detection event. In other words, the parameter STH represents an upper limit of the number of frames that can be stored in the storage space 151 before the presence of the motion detection event is detected, and the parameter MTH represents an upper limit of the number of frames that can be stored in the storage space 151 after the presence of the motion detection event is detected. If the number of frames of the data D1 is equal to the maximum number of frames defined by the parameter STH before the presence of the motion detection event is detected, the controller 170 may control the memory 150 to transmit the data D1 current stored to at least one host device. Similarly, if the number of frames of the data D1 is equal to the maximum number of frames defined by the parameter MTH after the presence of the motion detection event is detected, the controller 170 may control the memory 150 to transmit the data D1 current stored to at least one host device. In some embodiments, the numerical value of each the parameter STH and the parameter MTH may be, for example but not limited to, an integer greater than or equal to 1.

In the examples above, the multiple parameters ST, MT, STH and MTH are stored in a register of the controller 170; however, the present application is not limited to the examples above. In different embodiments, the multiple parameters ST, MT, STH and MTH may also be stored in registers within other circuits in the image generator 120.

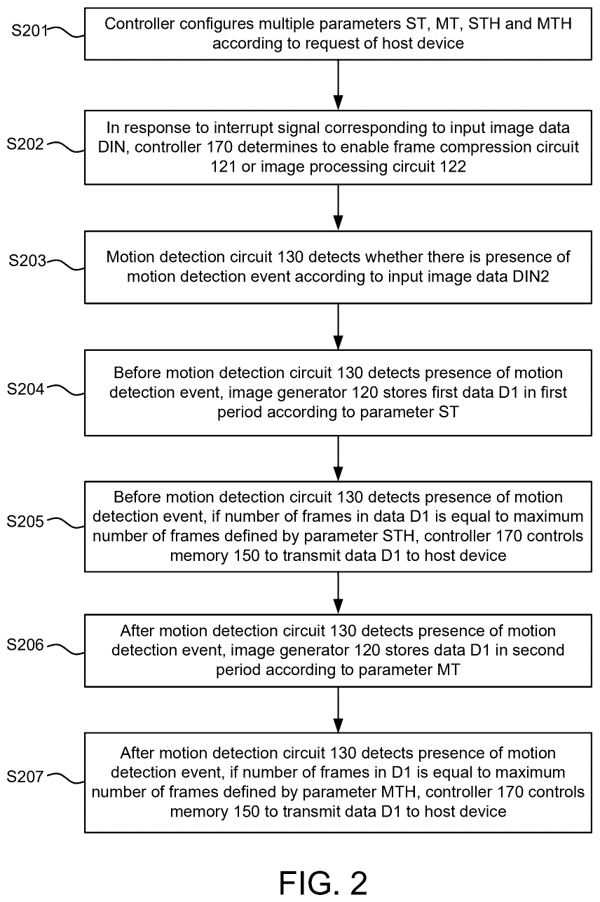

FIG. 2 shows a flowchart of operations of the image processing device 100 in FIG. 1 according to some embodiments of the present application. In operation S201, the controller 170 configures the multiple parameters ST, MT, STH and MTH according to a request of a host device. In operation S202, in response to an interrupt signal corresponding to the input image data DIN2, the controller 170 determines to enable the frame compression circuit 121 or the image processing circuit 122.

For example, the input image data DIN1 may include multiple frames, and the circuits including the input interface circuit 110, the auto-exposure circuit 115, the image generator 120 and the motion detection circuit 130 perform image processing by one frame after another. After a frame in the input image data DIN1 is completely transmitted, the input interface circuit 110 may issue an interrupt signal (not shown) corresponding to the frame to trigger the controller 170, such that the controller 170 may determine during a blank period between frames to enable the frame compression circuit 121 or the image processing circuit 122. If the controller 170 enables the frame compression circuit 121, the controller 170 may disable the image processing circuit 122 and the image encoding circuit 123 to reduce power consumption, and the motion detection circuit 130 remains able to detect the motion detection event according to the input image data DIN2. Alternatively, if the controller 170 enables the image processing circuit 122, the controller 170 may disable the frame compression circuit 121 to reduce power consumption, and the motion detection circuit 130 may detect the motion detection event according to the data D2 or the input image data DIN2.

In operation S203, the motion detection circuit 130 detects whether there is a presence of the motion detection event according to the input image data DIN2. In operation S204, before the motion detection circuit 130 detects the presence of the motion detection event, the image generator 120 stores the data D1 in a first period according to the parameter ST. In operation S205, if the number of frames of the data D1 is equal to the maximum number of frames defined by the parameter STH before the motion detection circuit 130 detects the presence of the motion detection event, the controller 170 controls the memory 150 to transmit the data D1 a host device.

As described above, when the motion detection circuit 130 detects the presence of the motion detection event, the motion detection circuit 130 issues an interrupt signal to notify the controller 170. Until the interrupt signal is received, it means that the motion detection circuit 130 has not yet detected the presence of the motion detection event. In some embodiments, during a period before the motion detection circuit 130 detects the motion detection event, the controller 170 may count the interrupt signal (for example, issued via the input interface circuit 110 as described above) of each of the multiple frames in the input image data DIN1 to generate a count value. The controller 170 may compare the count value with the parameter ST to control the image generator 120 to generate the data D1 in the first period before the presence of the motion detection event is detected. For example, assuming that the image encoding circuit 123 is selected to generate the data D1, the controller 170 may enable the image processing circuit 122 when the count value is equal to the number of frames (or equal to a value before the number of frames) defined by the parameter ST, so that the image processing circuit 122 may accordingly generate the data D2, thereby enabling the image encoding circuit 123 to generate a corresponding frame in the data D1 based on the data D2. After the corresponding frame of the data D1 is completely generated, the controller 170 may disable the image processing circuit 122 to stop the image encoding circuit 123 from generating the next frame of the data D1, and reset the count value so as to perform subsequent operations. Similarly, the controller 170 may selectively enable a corresponding circuit of the image generator 120 according to the parameter ST and the count value, and accordingly adjust data transmission in the image generator 120, so as to cause the image generator 120 to generate multiple frames in the data D1 in the first period. Next, if the number of frames in the data D1 stored is equal to the maximum number of frames defined by the parameter ST, the memory 150 may transmit the data D1 to the host device via the frame compression circuit 160 and the interface circuit 165.

In operation S206, after the motion detection circuit 130 detects the presence of the motion detection event, the image generator 120 stores the data D1 in a second period according to the parameter MT. In operation S207, if the number of frames of the data D1 is equal to the maximum number of frames defined by the parameter MTH after the motion detection circuit 130 detects the presence of the motion detection event, the controller 170 controls the memory 150 to transmit the data D1 a host device.

Similarly, in some embodiments, during a period after the motion detection circuit 130 detects the motion detection event, the controller 170 may count the interrupt signal (for example, issued via the input interface circuit 110 as described above) of each of the multiple frames in the input image data DIN1 to generate a count value. The controller 170 may compare the count value with the parameter MT to control the image generator 120 to generate the data D1 in the second period after the presence of the motion detection event is detected. For example, assuming that the image encoding circuit 123 is selected to generate the data D1, the controller 170 may enable the image processing circuit 122 when the count value is equal to the number of frames (or equal to a value before the number of frames) defined by the parameter MT, so that the image processing circuit 122 may accordingly generate the data D2, thereby enabling the image encoding circuit 123 to generate a corresponding in the data D1 based on the data D2. After the corresponding frame of the data D1 is completely generated, the controller 170 may disable the image processing circuit 122 to stop the image encoding circuit 123 from generating the next frame of the data D1, and reset the count value so as to perform subsequent operations. Similarly, the controller 170 may selectively enable a corresponding circuit of the image generator 120 according to the parameter MT and the count value, so as to cause the image generator 120 to generate multiple frames in the data D1 in the second period. Next, if the number of frames in the data D1 stored is equal to the maximum number of frames defined by the parameter MTH, the memory 150 may transmit the data D1 to the host device via the interface circuit 165.

The operation details above are described by selecting the image encoding circuit 123 to generate the data D1 as an example; however, the present application is not limited to the example above. In some other embodiments, if the image generator 120 selects the image compression circuit 121 to generate the data D1, the controller 170 may enable the image compression circuit 121 when the count value is equal to the number of frames (or equal to a value before the number of frames) defined by the parameter ST (or the parameter MT), thereby controlling the image generator 120 to store the data D1 in the first period (or in the second period).

FIG. 3 shows a schematic diagram of the data D1 in FIG. 1, the data processed by the motion detection circuit 130 and input image data DIN1 according to some embodiments of the present application. In FIG. 3, one line segment on the time axis represents one frame.

At a timing T1, the motion detection circuit 130 detects the presence of the motion detection event. In a period before the timing T1 (that is, before the presence of the motion detection event is detected), the image generator 120 stores the data D1 in the first period P1 (that is, the first period defined by the parameter ST). In a period after the timing T1 (that is, after the presence of the motion detection event is detected), the image generator 120 stores the data D1 in the first period P2 (that is, the second period defined by the parameter MT). As shown in FIG. 3, the period P1 is longer than the period P2. In other words, before the period P1, the image generator 120 may store one frame as the data D1 after several frames (corresponding to a time interval of the period P1). After the timing T1, the image generator 120 may store every frame (corresponding to a time interval of the period P2) as the data D1. It should be noted that, the configuration details of the period P1 and the period P2 in FIG. 3 are merely examples, and the present application is not limited to these examples.

On the other hand, in some embodiments, at the timing T1, the controller 170 may wake up a host device according to an interrupt signal corresponding the motion detection event. Thus, when the number of frames of the data D1 after the timing T1 is equal to the maximum number of frames (for example, at the timing T2) defined by the parameter MTH, the memory 150 may transmit the data D1 to the host device. In other words, in the image processing device 100, a wakeup time of the host device and a period in which images are collected after the presence of the motion detection event are at least partially overlapping, so as to achieve even better processing efficiency.

In some applications, the configuration details above are applicable to a parking mode in a driving recorder. For example, before a motion detection event such as detecting a collision or a contact of a still vehicle, a driving recorder may record image data captured in the longer period P1, so as to reduce power consumption and save a storage capacity of the memory 150. After a motion detection event such as detecting a collision or a contact of a still vehicle, a driving recorder may record image data captured in the shorter period P2, so as to obtain more complete image records. It should be noted that the application above is merely an example, and the present application is not limited to such example.

FIG. 4 shows a schematic diagram of an application example of the image processing device 100 in FIG. 1 according to some embodiments of the present application. In this example, at least one host device above includes a video capturing chip 400 and a network device 410. In some embodiments, the network device 410 may be coupled to the image processing device 100 via, for example but not limited to, a wireless network, to receive the data D4 (which is the data D1 generated before the motion detection event is detected). The video capturing chip 400 may receive the data D4 (which is the data D1 before the motion detection event is detected), and accordingly generate a video stream SD to thereby transmit the video stream SD to the network device 410. Thus, the network device 410 may upload the video stream SD and the data D1 received to a cloud space. The configuration above is capable of reducing the number of times that the video capturing chip 400 is woken up, so as to further reduce power consumption.

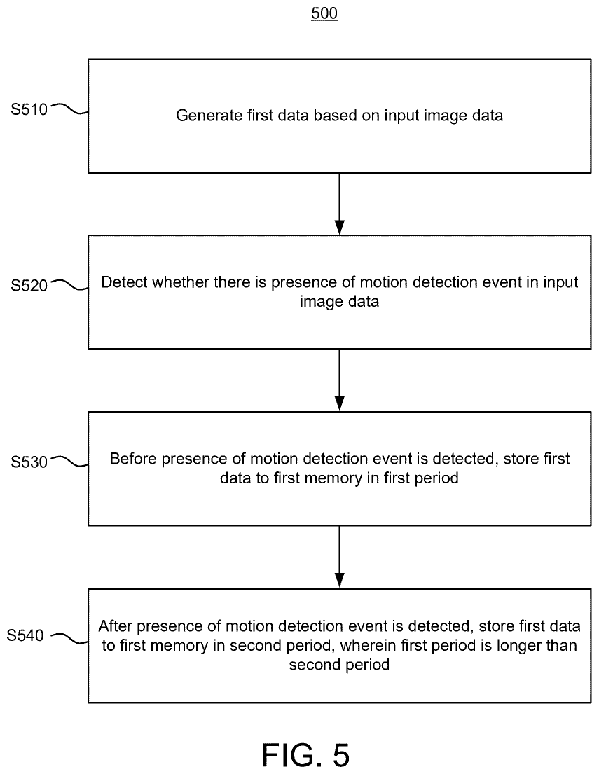

FIG. 5 shows a flowchart of an image processing method 500 according to some embodiments of the present application. In some embodiments, the image processing method 500 may be performed by, for example but not limited to, the image processing device 100 in FIG. 1.

In operation S510, first data is generated based on input image data. In operation S520, it is detected whether there is a presence of a motion detection event in the input image data. In operation S530, before the presence of the motion detection event is detected, the first data is stored to a memory in a first period. In operation S540, after the presence of the motion detection event is detected, the first data is stored to the memory in a second period, wherein the first period is longer than the second period.

Details associated with the multiple operations above can be referred from the details of the embodiments above, and are omitted herein. The plurality operations of the image processing method 500 above are merely examples, and are not limited to being performed in the order specified in this example. Without departing from the operation means and ranges of the various embodiments of the present application, additions, replacements, substitutions or omissions may be made to the operations of the image processing method 500, or the operations may be performed in different orders (for example, simultaneously performed or partially simultaneously performed).

In conclusion, the image processing device and method of some embodiments of the present application includes a motion detection mechanism and generates image data in different periods, thereby meeting application requirements for low power consumption.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image processing device, comprising:
a memory;
an image generator, generating first data based on input image data and storing the first data to the memory;
a motion detection circuit, detecting whether there is a presence of a motion detection event in the input image data;
wherein, before the motion detection circuit detects the presence of the motion detection event, the image generator stores the first data in a first period, and after the motion detection circuit detects the presence of the motion detection event, the image generator stores the first data in a second period, wherein the first period is longer than the second period.

2. The image processing device according to claim 1, further comprising:
a controller, configured to configure a first parameter and a second parameter;
wherein the first parameter is for setting the first period, and the second parameter is for setting a maximum number of frames of the first data before the motion detection circuit detects the presence of the motion detection event.

3. The image processing device according to claim 2, wherein the input image data comprises a plurality of frames, the controller counts an interrupt signal corresponding to each of the frames to generate a count value and compares the count value with the first parameter, so as to store the first data in the first period before the motion detection circuit detects the presence of the motion detection event.

4. The image processing device according to claim 2, wherein if the first period is greater than or equal to a predetermined value, the controller operates in a power-saving mode before the motion detection circuit detects the presence of the motion detection event.

5. The image processing device according to claim 2, wherein if the number of frames included in the first data is equal to the maximum number of frames before the motion detection circuit detects the presence of the motion detection event, the memory transmits the first data to a host device.

6. The image processing device according to claim 1, further comprising:
a controller, configured to configure a third parameter and a fourth parameter;
wherein the third parameter is for setting the second period, and the fourth parameter is for setting a maximum number of frames of the first data after the motion detection circuit detects the presence of the motion detection event.

7. The image processing device according to claim 6, wherein the input image data comprises a plurality of frames, the controller counts an interrupt signal corresponding to each of the frames to generate a count value and compares the count value with the third parameter, so as to store the first data in the second period after the motion detection circuit detects the presence of the motion detection event.

8. The image processing device according to claim 6, wherein if the number of frames included in the first data is equal to the maximum number of frames after the motion detection circuit detects the presence of the motion detection event, the memory transmits the first data to a host device.

9. An image processing method, comprising:
generating first data based on an input image data;
detecting whether there is a presence of a motion detection event in the input image data;
before the presence of the motion detection event is detected, storing the first data to a memory in a first period; and
after the presence of the motion detection event is detected, storing the first data to the memory in a second period, wherein the first period is longer than the second period.

10. The image processing method according to claim 9, further comprising:
configuring a first parameter and a second parameter;
wherein the first parameter is for setting the first period, and the second parameter is for setting a maximum number of frames of the first data before the motion detection circuit detects the presence of the motion detection event.
